(19) United States
(12) Patent Application Publication
(10) Pub. No.: US 2007/0118441 A1
(43) Pub. Date: May 24, 2007

(54) EDITABLE ELECTRONIC CATALOGS

(76) Inventors: Robert Chatwani, Fremont, CA (US); Robert Dean Veres, Evanston, IL (US); Nitin Duggal, Redwood City, CA (US); Pete Borowsky, Yardley, PA (US)

Correspondence Address: SCHWEGMAN, LUNDBERG, WOESSNER & KLUTH/EBAY, P.O. BOX 2938, MINNEAPOLIS, MN, 55402, US

(21) Appl. No.: 11/426,993

(22) Filed: Jun. 28, 2006

Related U.S. Application Data
(60) Provisional application No. 60/739,723, filed on Nov. 22, 2005.
(60) Provisional application No. 60/739,195, filed on Nov. 23, 2005.

(51) Int. Cl. G06F 17/30

(52) U.S. Cl. 705/27

(57) ABSTRACT

This document describes, among other things, systems and methods for managing a community-editable product catalog. A method receives, by a network-based commerce system, an indication from a client computer to create a listing for a product. The method determines whether a catalog entry associated with the product exists and when the catalog entry does not exist, prompts a user to create a new catalog entry and stores either the catalog entry or the new catalog entry in the network-based commerce system.

### CROSS-REFERENCE TO RELATED PATENT DOCUMENTS

This patent application claims the benefit of priority, under 35 U.S.C. Section 119(e), to Chatwani et al., U.S. Provisional Patent Application Ser. No. 60/739,723, entitled “Dynamically Editable Electronic Product Catalogs,” filed on Nov. 22, 2005 and to Chatwani et al., U.S. Provisional Patent Application Ser. No. 60/739,195, entitled “Editable Electronic Catalogs,” filed on Nov. 23, 2005, the contents of which are hereby incorporated by reference in their entireties.

### TECHNICAL FIELD

Embodiments of the inventive subject matter relate generally to the field of electronic commerce, and more specifically to methods and systems that facilitate the generation, editing, and/or accessing of catalog content associated with network-based commerce systems.

### BACKGROUND

More and more Internet users are realizing the ease and convenience of purchasing products and services through online catalogs, which are provided by network-based commerce systems. Catalog entries for various products and services may be presented to a user when the user computer interacts with a network-based commerce system, downloads catalog entry information, and displays the catalog entries on the computer's monitor via a user interface (e.g., one or more web pages). The user may then interact with the user interface to purchase the products and/or services.

Catalog content (e.g., a catalog entry) often includes licensable, proprietary information. Because the granting or withholding of the licenses typically is at the discretion of the owner of the content, a catalog developer may be restricted from creating a catalog with the desired breadth and depth.

### BRIEF DESCRIPTION OF THE DRAWINGS

FIG. 1 illustrates a schematic block diagram of a network-based commerce system, in accordance with an example embodiment;

FIG. 2 illustrates an example of a product detail page, in accordance with an example embodiment;

FIG. 3 illustrates a method for generating a catalog entry and/or listing, in accordance with an example embodiment;

FIG. 4 illustrates a flowchart of a method for editing a catalog entry, in accordance with an example embodiment; and

FIG. 5 illustrates a diagrammatic representation of a machine in the exemplary form of a computer system, within which a set or sequence of instructions for causing the machine to perform any one of the methodologies discussed herein may be executed.

### DETAILED DESCRIPTION

Methods and systems to generate, edit, and access catalog content in a network-based commerce system are described. In the following description, for purposes of explanation, numerous specific details are set forth in order to provide a thorough understanding of embodiments of the inventive subject matter. It will be evident, however, to one skilled in the art that embodiments of the inventive subject matter may be practiced without these specific details.

In various embodiments, “catalog content” includes one or more “catalog entries.” In one embodiment, catalog entries include any description, identifier, representation or information, stored digitally, which can describe a product generally, and which can be stored within or accessible to a network-based commerce system. A product can include, for example, a physical object or a digital object (e.g., electronically stored music, video, etc.). For example, a catalog entry can include one or more items of information in a group of information types that includes a product name, a product manufacturer, product physical characteristics (e.g., size, dimensions, weight, etc.), a product model, a year of manufacture, and other information.

As will be described in more detail later, a catalog entry can have associated therewith, zero or more listings, each of which describe a “product instance.” In an embodiment, a product instance includes a specific item (e.g., a particular Seiko watch for sale by an individual). In an embodiment, a listing can include information describing a product instance, in which the instance is a particular object being offered for sale. A listing can include information related to characteristics of that instance. For example, a listing can include one or more items of information in a group of information types that includes condition information for the product instance (e.g., damage, wear and tear, an indicator that the product instance is in excellent, fair or poor condition), product age, product location, shipping information, price, and other information.

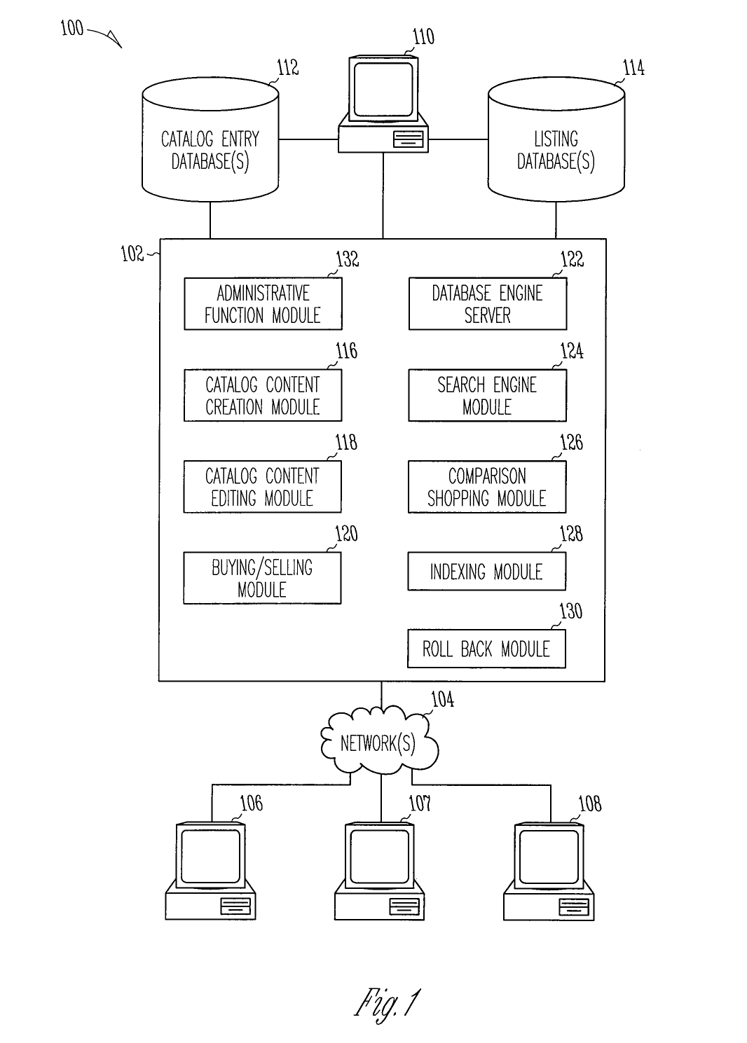

FIG. 1 illustrates a schematic block diagram of a network-based commerce system 100 in accordance with an example embodiment of the inventive subject matter. While exemplary embodiments of the inventive subject matter are described within the context of the network-based commerce system 100, embodiments of the inventive subject matter may find application in many different types of computer-based or network-based facilities or systems. Accordingly, the example embodiment of a network-based commerce system 100 is not intended to limit the scope of the inventive subject matter solely to such systems.

In an embodiment, network-based commerce system 100 includes at least one server system 102, which can communicate over one or more networks 104 to one or more end-user computers 106-108. Server system 102 additionally can communicate over one or more direct or networked connections with one or more administration computers 110 and one or more databases 112, 114.

Server system 102 can include, in various embodiments, one or more catalog entry creation modules 1 16, catalog content editing modules 118, buying/selling modules 120, database engine modules 122, search engine modules 124, comparison shopping modules 126, and/or indexing modules 128.

In an embodiment, server system 102 includes rollback module 130, which can be used to “rollback” or revert to a previous version of a product detail page (PDP). This is especially useful in cases of identified vandalism or mistaken edits. In an embodiment, server system 102 includes an administrative function module 132, which can provide one or more administrative functions, such as monitoring, maintaining, and managing the network-based commerce system 100. In an embodiment, administrative function module 132 can be used to lock, delete, or undelete a PDP. This functionality may be used in conjunction with a dispute resolution process, such as when a product manufacturer claims that copyrighted material is being used without authorization. For example, during a dispute, locking or deleting a PDP can result in a default PDP being used as a temporary replacement. The default PDP may include basic information, such as a name or model number, and be available for searches and to associate with product listings.

In an embodiment, when changes are made to a PDP, previous contributors are notified or alerted, such as via email. The notification or alert may include the changed content. The notification or alert provides notice to the contributors so that they may verify the changed content for accuracy, completeness, or other appropriate uses, and access server system 102 to revise the PDP entry if desired. Changes that trigger a notification or alert include rollbacks, such as by an administrator, user-contributed changes, manufacturer-contributed changes, or PDP deletions.

Server system 102 may also include one or more of a number of types of front-end servers, which may include one or more page servers, which deliver web pages (e.g., mark-up language documents), one or more picture servers, which dynamically deliver images to be displayed within Web pages, one or more listing servers, which facilitate category-based browsing of catalog entries and/or listings, and one or more ISAPI servers, which provide an interface to a back-end of the system 102. Server system 102 also may include, in an embodiment, one or more e-mail servers, which may provide automated e-mail communications to users of the network-based commerce system 100.

One or more API servers may provide a set of API functions for querying and writing to the network-based commerce system 100. APIs may be called through the HTTP transport protocol. In an embodiment, information is sent and received using a standard XML data format. Applications utilized to interact (e.g., upload transaction listings, review transaction listings, manage transaction listings, etc.) with the network-based commerce system 100 may be designed to use the APIs. Such applications may be in an HTML form or be a CGI program written in C++, Perl, Pascal, or any other programming language.

The page servers, API servers, picture servers, ISAPI servers, search servers, e-mail servers and a database engine server can individually, or in combination, act as a communication engine to facilitate communications between, for example, a client machine 106-108 and the network-based commerce system 100; act as a transaction engine to facilitate transactions between, for example, the client machine 106-108 and the network-based commerce system 100; and act as a display-engine to facilitate the display of catalog entries and/or listings on, for example, the client machine 106-108.

The back-end servers may include the database engine server, a search index server and a credit card database server, each of which maintains and facilitates access to a respective database.

In an embodiment, the network-based commerce system 100 is accessed by a client program, such as for example a browser (e.g., the Internet Explorer distributed by Microsoft Corp. of Redmond, Wash.) that executes on the client machine 106-108 and accesses the network-based commerce system via a network 104 such as, for example, the Internet. Other examples of networks that a client may utilize to access the network-based commerce system include a wide area network (WAN), a local area network (LAN), a wireless network (e.g., a cellular network), the Public Switched Telephone Network (PSTN) network, or the like. The client program that executes on the client machine 106-108 may also communicate with the network-based commerce system 100 via the API servers.

Server system 102 additionally may communicate with one or more databases (e.g., catalog entry database 112 and listing database 114). In an embodiment, a database engine server 122 may interface with and/or maintain multiple databases. In an embodiment, a first database 112 may be maintained for catalog entry information, and a second database 114 may be maintained for listing (or offering) information. The first database 112 may include licensed catalog content and/or unlicensed catalog content, as will be described in more detail later.

In an embodiment, catalog entries and listings can be distinct database entities. For example, a catalog entry can be represented by a record within a catalog entry database 112 for a particular Seiko watch model, and the catalog entry can contain a description that is specific to the product. A listing for a Seiko watch can describe an actual watch that belongs to a particular individual or entity, where that watch is being sold. The listing can be represented by a record within a listing database (e.g., listing database 114) for the actual watch, and the listing can include information that is particular to the actual watch.

In an embodiment, the catalog entry database 112 and/or the listing database 114 may have a structure that can vary based on the domain (e.g., DDG, B&I, Computers, Services, etc.). The catalog entry database 112 and/or the listing database 114 can also include a catalog entry table that contains columns to capture at least the following data: UPC, product title, and manufacturer. The catalog entry table may, in a further embodiment, be enhanced to include additional product data, such as one or more properties (who can edit or delete; type of listing; etc.), ratings, reviews, stock photos, domain, user-contributed images, etc.

The catalog entry database 112 and the listing database 114 can, in some embodiments, be implemented as relational databases, and can include a number of tables having entries, or records, that are linked by indices and keys. In an embodiment, a product identifier can be used as a key to link a catalog entry and associated listings. In an alternative embodiment, catalog entry database 112 and the listing database 114 can be implemented as collections of objects in an object-oriented database. In an embodiment, catalog entry database 112 and/or the listing database 114 can include a distributed database, however, in other embodiments catalog entry database 112 and/or the listing database 114 can include a central database.

In an embodiment, one or more databases can include a user table that contains a record for each user of a network-based commerce system 100. A user can operate as a seller, a buyer, or both, when utilizing a network-based commerce system 100. The listing database 114 also can include listings tables that may be linked to the user table. The listings tables can include a seller listings table and a buyer listings table. A user record in the user table can be linked to multiple listings that are being, or have been, listed or offered for sale via the network-based commerce system 100. In an embodiment, a link indicates whether the user is a seller or a buyer with respect to listings for which records exist within the listings tables.

The catalog entry database 112 and/or the listing database 114 can include one or more divisions in the form of categories provided in category tables. Each record within the category table can describe a respective category. In an embodiment, catalog entries and/or listings provided by the system are arranged in the categories. In an embodiment, a catalog entry and/or a listing can span or be related to multiple categories. These categories may be navigable by a user of the network-based commerce system to locate catalog entries and/or listings in specific categories. Thus, categories provide a mechanism to locate catalog entries and/or listings that may be browsed. In addition or alternately, an alphanumeric search mechanism can be provided by the search servers to allow a user to search for specific catalog entries or listings using search terms or phrases. In an embodiment, the category table describes multiple, hierarchical category data structures, and includes multiple category records, each of which describes the context of a particular category within the multiple hierarchical category structures. For example, the category table may describe a number of real, or actual, categories to which catalog entries and/or listing records, within the listings tables, may be linked.

The catalog entry database 112 and/or the listing database 114 can also include one or more attributes tables. Each record within the attributes table can describe a respective attribute associated with a catalog entry and/or listing. In an embodiment, the attributes table can describe multiple, hierarchical attribute data structures, and includes multiple attribute records, each of which describes the context of a particular attribute within the multiple hierarchical attribute structures. For example, the attributes table can describe a number of real, or actual, attributes to which listing records can be linked. Also, the attributes table can describe a number of real, or actual, attributes to which categories, within the category table, can be linked.

The catalog entry database 112 and/or the listing database 114 can also include a note table populated with note records that can be linked to one or more catalog entries and/or listing records and/or to one or more user records within the user table. Each note record within the note table can include, inter alia, a comment, description, history or other information pertaining to a catalog entry and/or to a listing being offered via the network-based commerce system 100, to a user of the network-based commerce system. The catalog entry database 112 and/or the listing database 114 can also include a targeted site table populated with targeted site records that can be linked to one or more listing records within the listings tables and/or to one or more user records within the user table.

The catalog entry database 112 and/or the listing database 114 can be populated automatically or manually from any one or more of a number of product databases. In an embodiment, one or more manufacturers and/or sellers can provide a database containing product data (e.g., UPC, title, manufacturer, description, model number, etc.), which can then be integrated into the database 112 and/or 114. Optionally, in an embodiment, the manufacturer and/or power seller can indicate to flag the product detail page (PDP) generated from such product data as read-only to the general community. Manufacturers and/or sellers may prefer this functionality to preserve consistency within a product line or product category. Additionally, a static read-only PDP can be persistent and can include a unique system ID, allowing affiliates to physically link to the PDP. In an embodiment, a persistent PDP includes text or links to ratings and/or reviews. In this way, a manufacturer or power seller can ensure that editorial or industry reviews, for example, are persistent and prominently displayed. In an embodiment, meta-tag content is included in a static PDP to ensure higher relevancy, such that they can be made to appear higher in a natural search or other search results.

A number of other exemplary tables may also be linked to the user table, namely a user past aliases table, a feedback table, a feedback details table, a bids table, an accounts table, and an account balances table. In an embodiment, the database also includes a batch table, a batch listings table, and a listings wait table.

It will be appreciated that the success of a seller in, for example, selling a listing may be dependent upon the catalog entry information and/or listing information provided when the catalog entry is displayed, and/or when the listing is posted to the network-based commerce system 100.

In an embodiment, a user at a client machine 106-108 can browse through or search within an online catalog associated with the network-based commerce system 100. The online catalog can include multiple categories of catalog entries. For example, the online catalog can include categories such as music, books, collectables, electronics, clothing, and the like.

In an embodiment, a catalog entry can be represented on a client computer 106-108 using a “product detail page” (PDP) or other visual representation. A PDP can include a generic description of a product, in an embodiment. In another embodiment, PDPs can maintain at least two views, such as a collapsed summary view and an expanded detailed view.

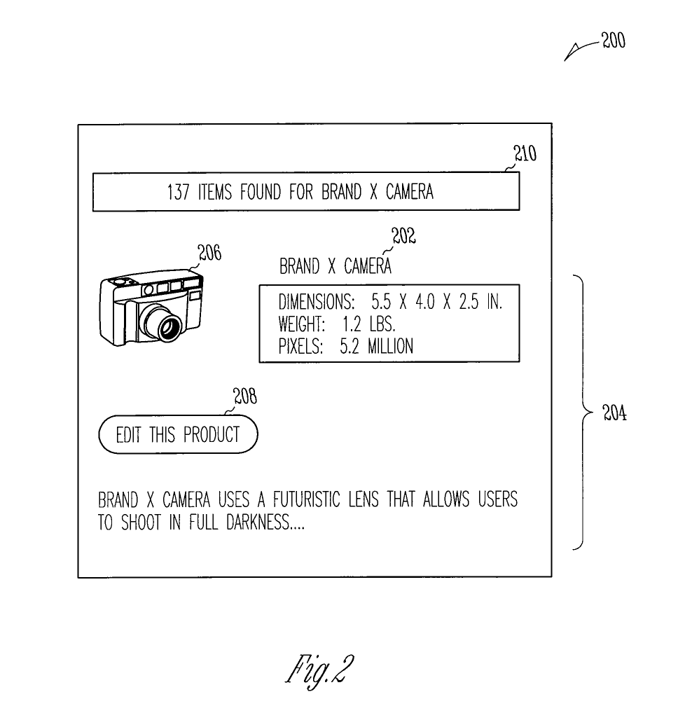

FIG. 2 illustrates an example of a product detail page 200, in accordance with an example embodiment. In an embodiment, the product detail page 200 includes a representation of a catalog entry. The product detail page 200 includes, in an embodiment, a product title 202, a product description 204, and a product image 206. In alternative embodiments, the product detail page 200 may include more or less information.

In an embodiment, as will be described in more detail later, a user can edit information within a catalog entry. Editable information can include any or all of the product title 202, the product description 204, and the product image 206. The product detail page 200 can include an element, such as element 208, which when selected, initiates an editing process.

The product detail page 200 also can include a listing indicator 210. In an embodiment, the listing indicator 210 can indicate whether or not any listings exist for the catalog entry. In other words, the listing indicator 210 can indicate whether any instances of the product are available for sale. In the present example, the listing indicator 210 indicates that 137 instances of the product are available for sale. In an alternate embodiment, the listing indicator 210 can include a list of the actual listings.

In an embodiment, a user may indicate (e.g., by clicking on listing indicator 210) that the user desires to view one or more of the listings. If the system 100 receives such an indication, then one or more of the listings may be displayed on the client computer 106-108. The user may then purchase one or more of the items represented in the listings.

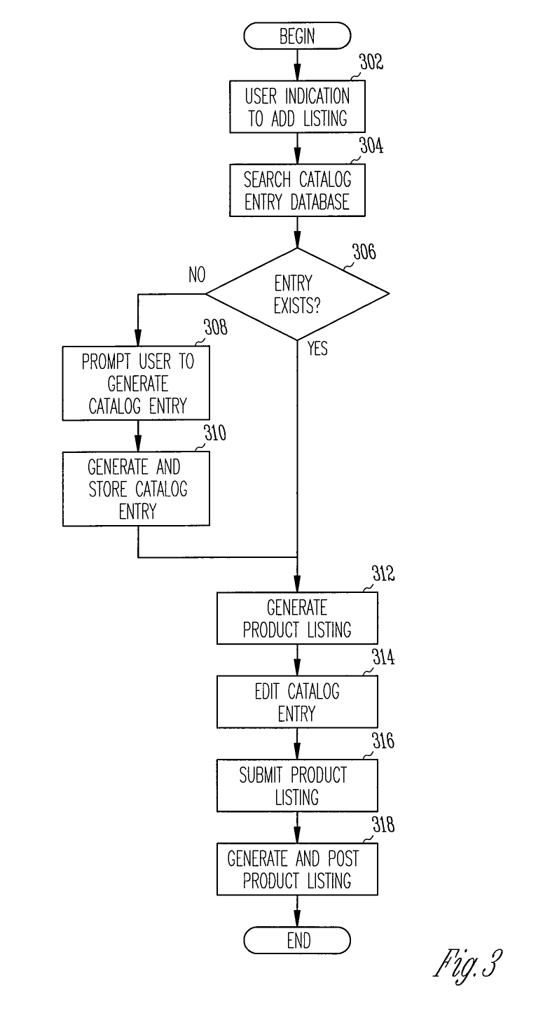

FIG. 3 illustrates a method for generating a catalog entry and/or listing, in accordance with an example embodiment. The method begins in block 302 by receiving an indication that a user wants to add a listing associated with a particular product. In an embodiment, the indication includes a product identifier (e.g., a product description, make, model, UPC code, ISBN, or other identifier).

In block 304, the system 100 searches the catalog entry database to determine if a catalog entry exists for the product identified. In an embodiment, the system 100 uses a UPC code provided by the user (e.g., seller) to search for a pre-existing catalog entry. In block 306, if such a catalog entry is found, some or all of the existing information can be used to pre-populate a catalog entry form so that the user may, for example, edit or confirm the information provided. If a determination is made, in block 306, that no catalog entry exists for the product, then in block 308, the system 100 prompts the user to generate a catalog entry. For example, the system 100 may provide a catalog entry creation form (e.g., an HTML page), within which the user may be prompted to enter a title (e.g., “watch”), a manufacturer (e.g., “Seiko”), a product identifier (e.g., a UPC and/or ISBN), product characteristics (e.g., year, materials, color, dimensions, weight, etc.), and other information that may be generally relevant. The user may also be prompted to upload a product photograph, image, and/or other information pertaining to the product.

In block 310, the system 100 received information entered by the user with which the system generates a catalog entry for the product. In an embodiment, the catalog entry is stored in a catalog entry database 112. In an embodiment, if the user provides a UPC that is not in the system 100, the new catalog entry is flagged and vetted before activating the new product.

Once a catalog entry is created, or if a determination is made in block 306 that a catalog entry does exist, then in block 312, the system 100 can generate a product listing for the specific instance of the product that the user desires to sell. In an embodiment, generating the product listing may include the system 100 pre-populating a product listing form with the catalog entry information and prompting the user for instance-specific information.

In block 314, the system 100 can prompt the user to determine if the user wants to edit the catalog entry. In an embodiment, the system provides one or more ways of enabling a user to edit a catalog entry. For example, when a user edits a field of the product listing form that was prepopulated with catalog entry information and the user submits the form with the edited field, the system will update the catalog entry in the catalog entry database 112 with the modified information. In another embodiment, the system can provide the user with one or more prompts (e.g., an “Edit Catalog Entry?” button) that enable the user to indicate a desire to edit the catalog entry. The prompts can be provided as part of a product listing form and/or as part of a catalog entry, when it is displayed on a user's computer (e.g., as the user is browsing or searching the catalog).

In an embodiment, a user may provide a textual description, which may or may not be delimited by a character delimiter (e.g., a comma) and the system can parse the input textual description to determine one or more of an attribute of a product, a photo, a title, or other elements which may appear in a catalog entry and/or a listing. The parsed data may then be presented to the user for verification before being further processed.

In an embodiment, one or more checkpoints are built into the system 100, which analyze content before or after an entry is created or edited. For example, a checkpoint can comprise of an information display, such as information provided to a user regarding issues such as copyright policies, appropriate content, and dispute resolution. In a further example, a checkpoint can be implemented as a program or an application that automatically ensures that content is appropriate. For example, a checkpoint program can use a “bad word” filter or a database of known copyrighted or trademarked phrases to censor submitted content.

At block 316, the system 100 receives a product listing from the user. At 318, the system 100 generates and posts the listing. In an embodiment, the product listing is stored in a listing database 112, and is relationally linked to the associated catalog entry using a key (e.g., a product identifier). The method then ends.

In certain embodiments of the inventive subject matter, a user can edit or modify a listing or item after it has been posted on the network-based commerce system 100. For example, in an embodiment, the system 100 can include a “Revise Your Item” (RYI) function.

In an embodiment, after a listing is associated with a catalog entry and posted, a user can then browse the catalog and encounter the catalog entry and listing, and/or may perform a search for the product within the catalog. In either event, a catalog entry can be represented on a client computer via a product detail page or other representation.

In an embodiment, content of a catalog entry is indexed by one or more search engines 124. The indexing could include optimizations for natural searching. The search engines 124 can provide results, in the form of data feeds, to other internal or external systems. For example, a category of “game consoles” can be indexed and the catalog entries (and associated content) of “Gamecube,” “Xbox,” and “Playstation” would be a result of a search for “game consoles” by a search engine. The result can then be fed to an external shopping system (e.g., shopping.com) and the product detail pages (PDPs) made available to the external system.

In a further embodiment, specific listing data can also be provided or syndicated to an internal or external search result display, such that listings of the products can be prominently featured and easily accessible by the consumer. In an embodiment, a seller who has created a listing can flag the listing as a “featured item,” where the featured item would then always be indicated in some way within the PDP. For example, at an additional cost, a seller could classify their listing as a featured item and then be guaranteed placement on the PDP. In another embodiment, a seller who is identified as a special seller because of reputation, sales data, or otherwise, can automatically have their listings associated with the related PDP. In another embodiment, a seller who initially creates a PDP can be granted the ability to associate any related listings with the PDP as featured items. The additional sales exposure may incentivize sellers to contribute product descriptions and further the goal of an expansive and robust catalog.

In an embodiment, the system 100 can enable a seller who has a database of product information already created to upload information within the database, whereupon the system 100 may automatically generate listings for the product. For example, in an embodiment, a seller can have a database that includes hundreds of books, where each book within the inventory may be represented by a record in the seller's database. In an embodiment, each record can include a product identifier (e.g., UPC and/or ISBN). The system 100 can enable the seller to upload the database information. The system may then generate a listing for those inventory items for which a catalog entry exists. In an embodiment, the listings and the catalog entries may be linked using the product identifiers previously existing within the seller's database entries.

In another embodiment, the system can automatically assign product identifiers to catalog entries, where no other external product identifier (e.g., UPC and/or ISBN) has previously been entered. For example, in an embodiment, external product identifiers may not exist for some collectable items, and/or the external product identifiers may not be known. In an embodiment, when a user creates a catalog entry without specifying an external product identifier, the system 100 automatically may generate a product identifier. Such an identifier may be referred to as an “internal product identifier” or a “system-generated product identifier.” In another embodiment, the system 100 can create a system-generated product identifier for all catalog entries, including those for which an external product identifier exists. A system-generated product identifier can be used as a key to link catalog entries and listings, in an embodiment.

System-generated product identifiers may be particularly advantageous, for example, in a collectables product category. In such a category, external product identifiers either may not exist or may not be know to a seller. A system-generated product identifier enables a catalog entry to be created even for items that have no known external product identifier. Accordingly, in an embodiment, a catalog system may include catalog entries for items for which no external product identifier exists.

In an embodiment, a seller can download system-generated product identifiers and match them within their inventory database. The seller can then upload the identifier and the inventory information to the system.

As mentioned previously, a user may have an opportunity to edit a catalog entry in the context of generating a listing. In an embodiment, a catalog entry may be edited at other times, as well. For example, a user who has accessed a particular catalog entry (e.g., via browsing or searching) can be given an opportunity to edit the catalog entry, in an embodiment.

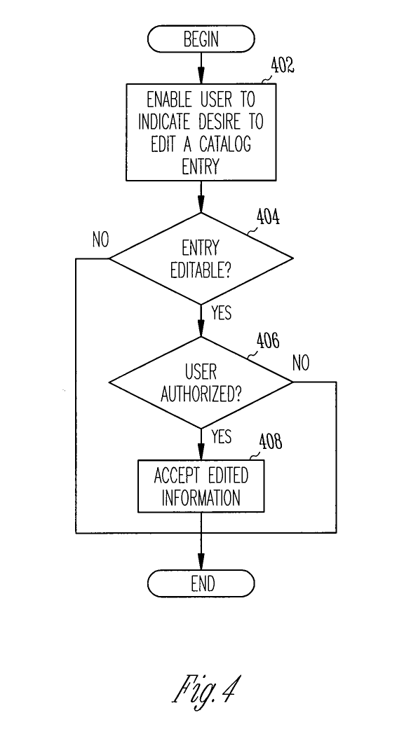

FIG. 4 illustrates a flowchart of a method for editing a catalog entry, in accordance with an example embodiment. The method begins, in block 402 by the system providing one or more prompts that enable a user to indicate that the user would like to edit a catalog entry. For example, a catalog entry page can include a page element (e.g., an “Edit Catalog Entry?” button), which the user can select to indicate a desire to edit the entry.

When a user has indicated a desire to edit the entry, then in block 404, a determination may be made whether the entry is editable. In an embodiment, all catalog entries may be editable by users. In another embodiment, one or more catalog entries may not be editable. Accordingly, in an embodiment, a system includes a database of catalog entries in which some catalog entries are editable by users and other catalog entries are not editable by users.

Whether or not a catalog entry is editable can be specified on an entry-by-entry basis (e.g., each catalog entry record includes a field indicating whether the entry is editable or not), in an embodiment. In another embodiment, selected portions of a category entry are specified as editable, while other portions are locked as read-only. For example, the product name and current manufacturer's suggested retail price (MSRP) fields are presented as read-only fields such that a user cannot make changes to them. However, the product's general description can be indicated as editable. In another embodiment, entire groups or categories of catalog entries can be designated by the system as being editable or not editable. For example, a category that includes musical compact discs can be designated as being not editable, while a category that includes collectables can be designated as being editable. As another example, licensed catalog content can be designated as not being editable, while user-contributed catalog content may be designated as being editable.

In one embodiment, the determination of whether an entry is editable is based on an identity of the contributor and an identity of those with editing rights. For example, in one configuration, any user can contribute content and any user can edit content. In another configuration, a seller is the sole contributor of content and is also the only person with editing rights to the content. In yet another configuration, a seller is the sole contributor of content; however, all users are able to edit the content. In yet another configuration, two or more sellers may contribute to a single content, which is then editable by any user.

In an embodiment, the content is a product detail page (PDP). The PDP can be accessed by other users of the system or alternately, the PDP can be flagged as private and only accessed by the content creator(s). However, allowing multiple users to access communally-derived content can result in higher quality content and more consistent presentation.

If an entry is editable, then in block 406, the system determines whether the user has authority to edit the entry. One or more criteria can be used, in various embodiments, to determine whether a user has authority to edit the entry. For example, if the user is registered with the system (e.g., a registered eBay buyer or seller), then access can be granted. As another example, a determination can be made, prior to allowing a catalog entry to be edited, whether the user has appropriate criteria (e.g., appropriate permissions, minimum feedback score, no prior history of misconduct (e.g., vandalism of the catalog), etc.).

If the user has authority to edit the entry, then in block 408, the system accepts the edited information and a new version of the catalog entry is saved in the catalog entry database. In an embodiment, a user may provide a textual description, which may or may not be delimited by a character delimiter (e.g., a comma) and the system can parse the input textual description to determine one or more of an attribute of a product, a photo, a title, or other elements which may appear in a PDP.

In an embodiment, the system can maintain one or more prior versions of a catalog entry. An administrator and/or a user can, in certain circumstances, be able to revert back to a prior version, if desired. The method then ends.

In an embodiment, a user can choose not to edit a catalog entry directly or may not have the necessary privileges to do so. In this case, a feedback mechanism can be used to notify another party (i.e., a content owner) of the user's desire to change the content of a catalog entry. For example, a user may determine that a model number or description on a catalog entry is incorrect, but because the catalog entry is controlled by the manufacturer, the user does not have the ability to change the content. The user can then contact the content owner using methods such as a web form programmed in HTML or an email link. The content of the web form or email message can then be automatically forwarded to the content owner. In an embodiment, after the content owner addresses the issue raised by the user, the user is automatically notified of the resulting content change. For example, the user receives an email message from a “change tracking system” after the content owner has updated the content.

The feedback mechanism can also be used to allow users to acclimate to a user-editable catalog system. For example, initially, users may be hesitant to make changes to a product detail page, even though they could. However, the user may feel comfortable providing feedback via a web-based form. In an example, an email is generated and sent to the user encouraging the user to edit the page directly and explaining the purpose and goals of a community-controlled catalog system.

Embodiments of the inventive subject matter may provide systems and methods for which commercial content (e.g., catalog entries) may be edited by a community of users who may or may not be affiliated with the provider of the commercial content. Embodiments of the inventive subject matter may provide systems and methods for generating, storing, and/or providing to users catalog entries within a database of entries that includes a subset of licensed catalog content and a subset of user-editable and unlicensed catalog content.

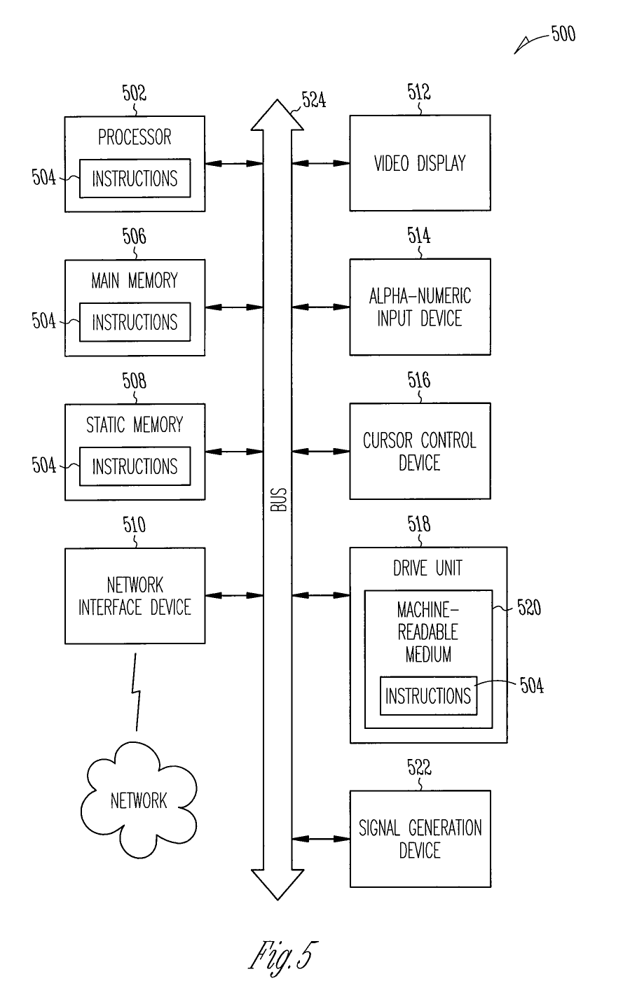

FIG. 5 illustrates a diagrammatic representation of a machine in the exemplary form of a computer system 500 within which a set or sequence of instructions, for causing the machine to perform any one of the methodologies discussed herein, may be executed. In alternative embodiments, the machine may comprise a computer, a network router, a network switch, a network bridge, Personal Digital Assistant (PDA), a cellular telephone, a web appliance, set-top box (STB) or any machine capable of executing a sequence of instructions that specify actions to be taken by that machine.

The computer system 500 includes a processor 502, a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520 to interface the computer system to a network 522.

The disk drive unit 516 includes a machine-readable medium 524 on which is stored a set of instructions or software 526 embodying any one, or all, of the methodologies described herein. The software 526 is also shown to reside, completely or at least partially, within the main memory 504 and/or within the processor 502. The software 526 may further be transmitted or received via the network interface device 520. For the purposes of this specification, the term “machine-readable medium” shall be taken to include any medium which is capable of storing or encoding a sequence of instructions for execution by the machine and that cause the machine to perform any one of the methodologies of the inventive subject matter. The term “machine-readable medium” shall accordingly be taken to include, but not be limited to, solid-state memories, optical and magnetic disks, and carrier wave signals. Further, while the software is shown in FIG. 5 to reside within a single device, it will be appreciated that the software could be distributed across multiple machines or storage media, which may include the machine-readable medium.

The foregoing description of specific embodiments reveals the general nature of the inventive subject matter sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents and variations as fall within the spirit and broad scope of the appended claims.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMS), read only memories (ROMs), and the like.

In the foregoing description of various embodiments, reference is made to the accompanying drawings, which form a part hereof and show, by way of illustration, specific embodiments in which the inventive subject matter may be practiced. Various embodiments are described in sufficient detail to enable those skilled in the art to practice the inventive subject matter, and it is to be understood that other embodiments may be utilized, and that process or mechanical changes may be made, without departing from the scope of the inventive subject matter.

Embodiments of the inventive subject matter may be referred to, individually and/or collectively, herein by the term “inventive subject matter” merely for convenience and without intending to voluntarily limit the scope of this application to any single inventive subject matter or inventive concept if more than one is, in fact, disclosed. It will be recognized that the methods of various embodiments can be combined in practice, either concurrently or in succession. Various permutations and combinations may be readily apparent to those skilled in the art.

What is claimed is:

1. A computer-implemented method to manage a community-editable product catalog, comprising:
receiving, by a network-based commerce system, an indication from a client computer to create a listing for a product;
determining whether a catalog entry associated with the product exists;
when the catalog entry does not exist, prompting a user to create a new catalog entry; and
storing either the catalog entry or the new catalog entry in the network-based commerce system.

2. The computer-implemented method of claim 1, further comprising:
when the catalog entry does exist, providing the user with the ability to edit the catalog entry.

3. The computer-implemented method of claim 2, wherein the ability to edit the catalog entry includes the ability to edit at least one of a product title, a product description, and a product image.

4. The computer-implemented method of claim 2, further comprising:
determining whether the catalog entry may be edited.

5. The computer-implemented method of claim 2, further comprising:
determining whether the user is authorized to edit the catalog entry.

6. The computer-implemented method of claim 2, further comprising:
maintaining one or more prior versions of the catalog entry.

7. The computer-implemented method of claim 2, further comprising:
receiving a textual description of the catalog entry; and
parsing the textual description to identify at least one of an attribute, a photo, a title, or an element of a product description.

8. The computer-implemented method of claim 1, wherein the product is a collectable item.

9. A computer-implemented method comprising:
receiving, by a network-based commerce system, information describing a product;
automatically assigning a system-generated product identifier to the product; and
relating a catalog entry for the product with one or more listings for the product using the system-generated product identifier, wherein the catalog entry may be edited by a user of the network-based commerce system.

10. The computer-implemented method of claim 9, wherein the user is one or more of a seller and a buyer.

11. A computer-implemented method comprising:
receiving, by a network-based commerce system, one or more product descriptions from a client computer, wherein each product description is associated with an item;
generating a listing for each of the product descriptions, wherein each listing includes a product identifier associated with the product description; and
relating a catalog entry with each listing using the product identifier.

12. The computer-implemented method of claim 11, wherein the product identifier is an automatically assigned system-generated product identifier.

13. A network-based commerce system, comprising:
at least one server;
a first database, which includes at least one catalog entry that may be edited by a user of a client computer in communication with the server; and
a second database, which includes at least one listing, which is associated with the at least one catalog entry.

14. The system of claim 13, wherein the first database further includes at least one catalog entry that may not be edited by the user.

15. The system of claim 13, wherein the first database includes one or more licensed catalog entries and one or more unlicensed catalog entries.

16. A network-based commerce system comprising:
means for enabling a first user to create a catalog entry; and
means for enabling a second user to edit the catalog entry.

17. A computer-implemented method comprising:
receiving an indication that a user wants to edit at least a portion of a catalog entry;
determining whether the portion of the catalog entry is editable;
determining whether the user is authorized to edit the portion of the catalog entry;
receiving one or more edited portions of the catalog entry; and
storing the edited catalog entry.

18. The computer-implemented method of claim 17, further comprising:
maintaining one or more prior versions of the catalog entry.

19. The computer-implemented method of claim 17, wherein the receiving an indication is performed using a feedback mechanism.

20. The computer-implemented method of claim 17, wherein the portion of the catalog entry includes a product title, a product description, and a product image.

21. A computer-readable medium having instructions that, when executed in a computer, provide a user-editable catalog by:
receiving an indication that a user wants to edit at least a portion of a catalog entry;
determining whether the portion of the catalog entry is editable;
determining whether the user is authorized to edit the portion of the catalog entry;
receiving one or more edited portions of the catalog entry; and
storing the edited catalog entry.
